(19) United States
(12) Patent Application Publication
(10) Pub. No.: US 2022/0043661 A1
(43) Pub. Date: Feb. 10, 2022

(54) SYSTEMS, DEVICES AND METHODS FOR DYNAMIC GENERATION OF DIGITAL INTERACTIVE CONTENT

(71) Applicants: Victor Gao, Delray Beach, FL (US); Adam Berger, Woodcliff Lake, NJ (US); Seokhoon Choi, Forest Hills, NJ (US)

(72) Inventors: Victor Gao, Delray Beach, FL (US); Adam Berger, Woodcliff Lake, NJ (US); Seokhoon Choi, Forest Hills, NJ (US)

(73) Assignee: Vigeo Technologies, Inc., New York, NY (US)

(21) Appl. No.: 17/508,219

(22) Filed: Oct. 22, 2021

Related U.S. Application Data
(63) Continuation of application No. PCT/US2020/029501, filed on Apr. 23, 2020.
(60) Provisional application No. 62/837,820, filed on Apr. 24, 2019.

(51) Int. Cl. G06F 9/451; G06F 3/0482; G06F 3/16

(52) U.S. Cl. CPC G06F 9/451; G09G 2354/00; G06F 3/167; G06F 3/0482

(57) ABSTRACT

Systems and methods for dynamic generation of a user interface for display on a display device of a user are described herein. A first set of payload elements associated with a user interface element to be rendered on the user interface can be identified. The first set of payload elements can be filtered by comparing keywords of each payload element to a user interface keyword to generate a second set of payload elements. The second set of payload elements can be filtered by comparing logic of each payload element to user parameters. A final payload element can be selected based on weighted random selection. The user interface can be rendered on the display with the final payload element as the user interface element.

### CROSS-REFERENCE TO RELATED APPLICATIONS

This application is a by-pass continuation application of International Application No. PCT/US2020/029501, entitled “SYSTEMS, DEVICES AND METHODS FOR DYNAIC GENERATION OF DIGITAL INTERACTIVE CONTENT,” filed on Apr. 23, 2020, which claims priority to, and the benefit of, U.S. Application No. 62/837,820, entitled “Systems, Devices, and Methods for Dynamic Generation of Digital Interactive Content,” filed on Apr. 24, 2019, the disclosure of which is incorporated herein by reference in its entirety.

### BACKGROUND

With the innovations in digital technology, digital interactive content has become ubiquitous. From video games, quizzes, ebooks, interactive television, digital advertising, and other software applications, interactive content enables active engagement of its users. The user becomes an integral part of a dynamic, two-way experience. By using interactive content, users can be provided with relevant accessible information while keeping them engaged.

Most businesses are using interactive content as a means of gaining an edge over their competition. For instance, by engaging potential customers using the immersive nature of interactive content, these customers may spend more time engaging with the business. This in turn positively impacts businesses by improving brand loyalty, repeat customers, profitability, and general reputation.

### SUMMARY

The Inventors have recognized and appreciated that conventional interactive content has major drawbacks. First, most interactive content is not tailored to a user's specific context. While several platforms—notably in e-commerce, social media, digital advertising, and online movie and music streaming services—claim to adapt the appearance and ordering of content to specific user needs, there is no personalization within the content itself. Put differently, most users are repeatedly provided with the same content over time (e.g., same survey, same user interface, etc.) in order to keep them engaged. However, different users often have different taste, choice, and behavioral patterns that is not usually reflected in the content.

Second, conventional interactive content often does not display, dispatch, and/or otherwise emulate human-like interactive behavior. Said another way, conventional interactive content does not respond to or interact with the user in a human-like manner in response to the user's actions or input. In such instances, it is often obvious to users that all interactivity within existing content is 100% machine-mediated. On the other hand, the Inventors have recognized and appreciated that a user will be more engaged when the interactive content provides feedback that emulates a human interaction (e.g., audio content that is more like a human conversation than one that plays a pre-recorded message).

Third, conventional interactive content is often not time-controlled or time-sensitive in terms of responsiveness to the user. For example, conventional interactive content does not provide for human-like time lapse in responding to a user's question.

In order to truly engage all users alike, the Inventors have recognized and appreciated that there is hence an unmet need to tailor interactive content to provide the user with time-controlled human-like experience.

In view of the foregoing, systems and methods for dynamic generation of a user interface for display on a display device of a user is disclosed herein. In one implementation, the method includes (a) receiving a first specification of a user interface element to be rendered on the user interface. The specification of the user interface element can include one or more first user interface keywords. The user interface is a first user interface of a set of sequential user interfaces associated with the user. The set of sequential user interfaces is associated with one or more user parameters of the user. The method also includes (b) identifying a first set of payload elements as associated with the user interface element and deemed selectable for rendering as the user interface element on the user interface. Each payload element can include a specification of: one or more payload keywords, selection logic, and a payload weight. The method also includes (c) filtering the first set of payload elements based on comparing the one or more payload keywords of each payload element of the first set of payload elements against the one or more user interface keywords to generate a second set of payload elements, (d) filtering the second set of payload elements based on comparing the selection logic of each payload element of the second set of payload elements against the one or more user parameters to generate a third set of payload elements, (e) selecting, via weighted random selection, a selected first payload element from the third set of payload elements based on the payload weight of each payload element of the third set of payload elements, and (f) rendering the first user interface on the display of the display device with the selected first payload element as the user interface element.

In one implementation, the method can further include (g) receiving a second specification of the user interface element to be rendered on a second user interface of the set of sequential user interfaces. The specification of the user interface element can include one or more second user interface keywords. The method also includes (h) performing steps (b)-(e) to select a selected second payload element from the first set of payload elements. The selected second payload element can be different from the selected first payload element by virtue of the weighted random selection. The method can also include rendering the second user interface on the display of the display device with the selected second payload element as the user interface element.

In some implementations, the selected first payload element and another payload element associated with a second user element can be associated via a payload map. The method can further include (j) receiving, after step (f), from the user, a selection of the first payload element, and (k) modifying a specification of the second user interface of the set of sequential user interfaces to include the other payload element.

In some implementations, the user interface element can include one or more of text, an image, an animated image, a video, audio, a hyperlink, or a phone call. In some implementations, the user interface element is a first user interface element of a set of user interface elements on the first user interface. The set of user interface elements can define a component of the first user interface.

In some implementations, the component includes a list and each user interface element of the set of user interface element is a selectable option of the list. In some implementations, the component includes a set of buttons and each user interface element of the set of user interface element is a selectable button of the set of buttons.

In some implementations, the rendering at step (f) further comprises rendering the first user interface as part of rendering a module of user interfaces of the set of user interfaces. In some implementations, the module is associated with: one or more user interactions different from the set of user interfaces, and an order for the contiguous rendering, responsive to user input, of each user interface within the set of user interfaces, and for each interaction of the one or more user interactions.

In some implementations, the module is further associated with timing information for the rendering of at least one user interface of the set of user interfaces, for at least one interaction of the one or more user interaction, or both.

In some implementations, the timing information is based on one or more of the payload elements. In some implementations, the rendering at step (f) further comprises rendering the module of user interfaces as a first module of a set of modules. In some implementations, the rendering at step (f) further comprises rendering, after a first time duration after the first module, a second module of the set of modules.

In one implementation, a system for dynamic generation of a user interface for display on a display device of a user is described herein. The system can include a controller to: (i) receive a first specification of a user interface element to be rendered on the user interface. The specification of the user interface element can include one or more first user interface keywords. The user interface can be a first user interface of a set of sequential user interfaces associated with the user. The set of sequential user interfaces can associated with one or more user parameters of the user. The controller can also identify a first set of payload elements as associated with the user interface element and deemed selectable for rendering as the user interface element on the user interface. Each payload element including a specification of: one or more payload keywords, selection logic, and a payload weight. The controller can also (iii) filter the first set of payload elements based on comparing the one or more payload keywords of each payload element of the first set of payload elements against the one or more user interface keywords to generate a second set of payload elements, (iv) filter the second set of payload elements based on comparing the selection logic of each payload element of the second set of payload elements against the one or more user parameters to generate a third set of payload elements, (v) select, via weighted random selection, a selected first payload element from the third set of payload elements based on the payload weight of each payload element of the third set of payload elements, and (vi) transmit, to the display device, a specification of the first user interface with the selected first payload element as the user interface element, such that the display device render the first user interface on the display with the selected first payload element as the user interface element.

In some implementations, the controller is further configured to: (vii) receive a second specification of the user interface element to be rendered on a second user interface of the set of sequential user interfaces. The specification of the user interface element can include one or more second user interface keywords. The controller can also (viii) perform steps (ii)-(v) to select a selected second payload element from the first set of payload elements. The selected second payload element can be different from the selected first payload element by virtue of the weighted random selection. The controller can also (ix) transmit the selected second payload element to the display device, such that the display device renders the second user interface on the display with the selected second payload element as the user interface element.

In some implementations, The selected first payload element and another payload element associated with a second user element are associated via a payload map. The controller is further configured to (x) receive, after (vi), from the user, a selection of the first payload element, and (xi) modify a specification of the second user interface of the set of sequential user interfaces to include the other payload element.

In some implementations, the user interface element can include one or more of text, an image, an animated image, a video, audio, a hyperlink, or a phone call.

In some implementations, the user interface element is a first user interface element of a set of user interface elements on the first user interface. The set of user interface elements can define a component of the first user interface. In some implementations, the component includes a list and each user interface element of the set of user interface element is a selectable option of the list. In some implementations, the component includes a set of buttons and each user interface element of the set of user interface element is a selectable button of the set of buttons.

In some implementations, the display device is further configured to render the first user interface as part of rendering a module of user interfaces of the set of user interfaces.

In some implementations, the module is associated with: one or more user interactions different from the set of user interfaces, and an order for the contiguous rendering, responsive to user input, of each user interface within the set of user interfaces, and for each interaction of the one or more user interactions.

In some implementations, the module is further associated with timing information for the rendering of at least one user interface of the set of user interfaces, for at least one interaction of the one or more user interaction, or both. In some implementations, the timing information is based on one or more of the payload elements.

In some implementations, the display device is further configured to render the module of user interfaces as a first module of a set of modules. In some implementations, the display device is configured to render, after a first time duration after the first module, a second module of the set of modules.

All combinations of the foregoing concepts and additional concepts are discussed in greater detail below (provided such concepts are not mutually inconsistent) and are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a system for dynamic generation of digital interactive content.

FIG. 2 illustrates various components for dynamic generation of digital interactive content.

FIG. 3 also illustrates various components for dynamic generation of digital interactive content.

FIGS. 4A-4B illustrate an example vJourney.

FIG. 5 is a flowchart illustrating a method for dynamic generation of digital interactive content.

### DETAILED DESCRIPTION

Following below are more detailed descriptions of various concepts related to, and implementations of, systems, devices and methods for dynamic generation of digital interactive content. It should be appreciated that various concepts introduced above and discussed in greater detail below may be implemented in numerous ways. Examples of specific implementations and applications are provided primarily for illustrative purposes to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

Aspects of the systems, devices, and method disclosed herein are generally directed to dynamic generation of digital interactive content. Specifically, disclosed herein are systems, devices, and methods for dispatching human-like, time-controlled, polymorphic content to enhance user engagement in a sequence of bilateral digital interactions between the user and another entity (e.g., via the user's mobile device).

Polymorphic content can be generally characterized as various forms of text, visual (e.g., images or animations), audio, and/or interactive (e.g., web links) material delivered or rendered (e.g., to users) by the systems and/or devices disclosed herein that changes between users and/or uses depending on factors such as (but not limited to) the context at the time of delivery, pre-programmed rules, automatically learned factors, and/or random chance/selection. In various innovative aspects described herein, employing polymorphic content in a sequence of bilateral digital interactions between a given user and another entity (e.g., a platform server as described herein) effectively facilitates (and in many instances enhances) user engagement and mitigates user fatigue by employing familiar and/or semantically similar content or content patterns in a varying and variable manner that maintains freshness over the course of interactions while being meaningful to the user at all times.

Digital interactive content can improve user engagement because of its immersive nature. However, existing approaches often provide the same content to different users. This can negatively impact user engagement due to user boredom and/or due to user confusion with interacting with generic content, ultimately leading to user frustration.

In order to provide varied content to different users, multiple combinations of usable content may need to be considered based on every users' behavioral patterns, interest, choices, and/or the like. Put differently, if the digital interactive content is to be tailored to every user, a platform providing such digital interactive content should consider each user's behavior, choices, interests, and/or the like, and tailor the content accordingly. One conventional way to do so is to generate a separate set of content (e.g., user interfaces) for each user. However, such an approach, while simply programmatically, is highly inefficient from a scalability and storage perspective. Specifically, scalability issues can arise because whenever a new user is added, a completely new set of content needs to be generated, and may require manual intervention to do so. Storage issues can arise because storage requirements associated with storing all content for each user can be massive, and scale in an unsustainable way. Inefficiencies of storage can also arise, because while some content (e.g., name, user profile image) can be varied across users, some content (e.g., interface background, certain icons) is likely to be redundant as well, but is repeated nonetheless.

Aspects disclosed herein can provide for user-specific adaptive user content, both on a per-interface basis (e.g., a single web page, or a single visual page on a smartphone application) and over time for the user based on varied, user-specific consumption of interface elements/components. In this manner, a unified set of such interface templates and interface elements/components can generate a significant number of unique user experiences in a scalable yet storage-efficient manner.

Generally, and as explained in more detail later, aspects disclosed herein can employ a modular, hierarchical approach to design the digital interactive content. For instance, multiple user interface elements can collectively form, or be included in, a user interface.

A collection of user interfaces can form, or be part of, an action and/or task that is to be completed before moving to the next action and/or task. A series of actions and/or task can form, or be part of, a unified journey that enables a user to complete a specified task.

To further enhance the varied, user-specific content that can be provided to a user while maintaining the benefits of the approaches described herein, aspects of the interfaces, actions, tasks, journey, and/or the like can evolve over time. For example, aspects disclosed herein can use machine learning techniques to modify one or more user interfaces yet to be presented to a user based on historical user interactions.

In this manner, the systems, methods, and devices disclosed herein can provide polymorphic content to users in a sequence of bilateral digital interactions, such as to guide the user to achieve an end goal. For instance, the sequences of digital interactions can guide a user in a very user-specific manner to pay a loan, run a business, consolidate a debt, prepare for college admission, train for a new career, plan for retirement, or achieve a health outcome, and/or the like.

System for Dynamic Generation of Human-Like, Time-Controlled, Polymorphic Digital Interactive Content

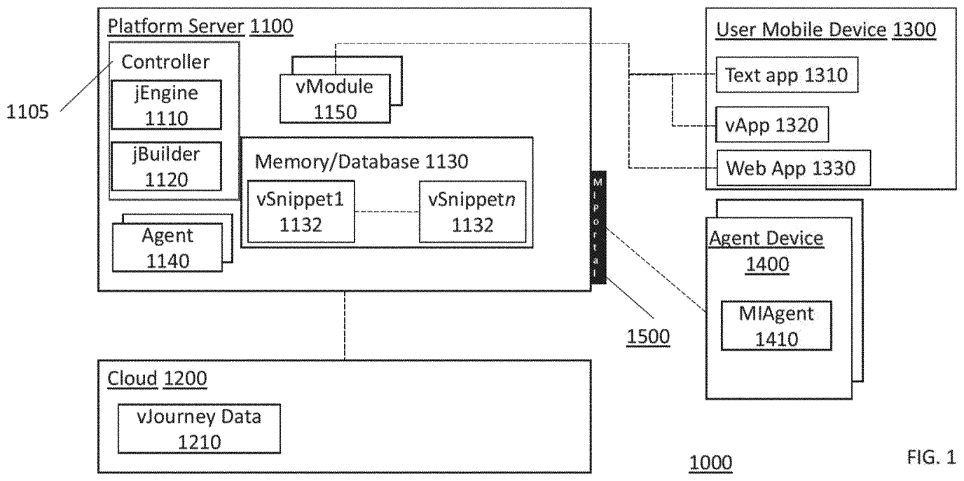

FIG. 1 is a schematic illustration of an environment/system 1000 in which dynamic generation of digital interactive content can be implemented and/or carried out. The system 1000 includes a platform server 1100. The server 1100 can interact with storage 1200, illustrated herein as a cloud-based storage platform, for storing any data generated and/or consumed by the approaches detailed herein. The server 1100 can also interact with a mobile user device 1300, such as a Smartphone, to deliver polymorphic content to the device 1300, such as via a texting application 1310, a proprietary cloud-based application vApp 1320, other applications 1330 running on the device 1300, and/or the like. The server 1100 can also be in communication with agent device(s) 1400 via a hardware and/or software interface referred to here as an MIPortal 1500. Each agent device 1400 can connect to the MIPortal 1500 to execute one or more actions that can enable an operator of the agent device 1400 known as the MIAgent 1410 to provide manual input, modification, etc. of any aspect of operation of the server 1000. The server 1000 gathers and automatically learns patterns based on the collective actions of these MIAgents 1410 issued over agent devices 1400, and subsequently generates these actions automatically in similar contexts.

The server 1100 includes at least a controller 1105 and a memory/database 1130. Unless indicated otherwise, all components illustrated within the server 1100 can be in communication with each other. It will also be understood that the database and the memory can be separate data stores. In some embodiments, the memory/database 1130 can constitute one or more databases. Further, in other embodiments, at least one database can be external to the server 1100. The server 1100 can also include one or more input/output (I/O) interfaces (not shown), implemented in software and/or hardware, for other components of the server 1100, and/or external to the server 1100 and/or the system 1000, to interact with the server 1100.

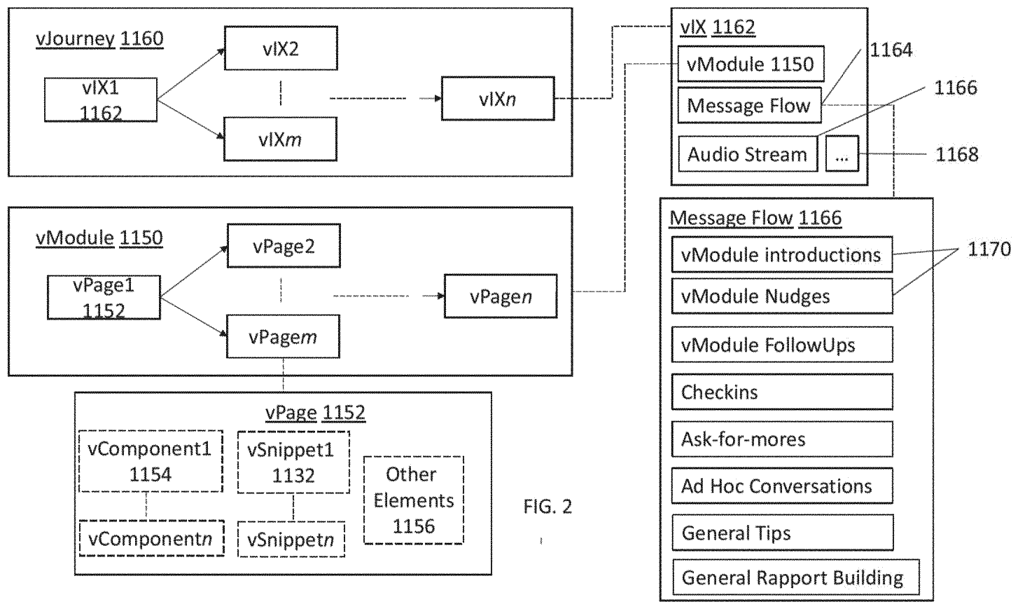

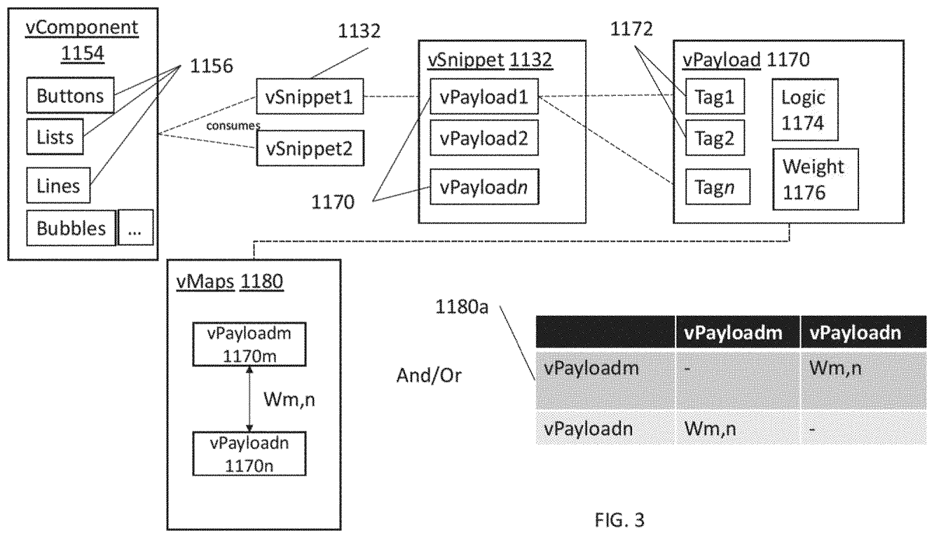

The memory/database 1130 can encompass, for example, a random access memory (RAM), a memory buffer, a hard drive, a database, an erasable programmable read-only memory (EPROM), an electrically erasable read-only memory (EEPROM), a read-only memory (ROM), Flash memory, and/or so forth. The memory/database 1130 (referred to herein as the database 1130 for simplicity) can store instructions to cause the controller 1105 to execute processes and/or functions associated with the server 1100 and/or the system 1000. As illustrated in FIG. 1, the database 1130 can store a set of data structures called vSnippets 1132, which provide innovative building blocks for creating polymorphic content, as explained in greater detail with respect to FIGS. 2-3.

The controller 1105 can be any suitable processing device configured to run and/or execute a set of instructions or code associated with the server 1100. The controller 1105 can be, for example, a general purpose processor, a Field Programmable Gate Array (FPGA), an Application Specific Integrated Circuit (ASIC), a Digital Signal Processor (DSP), and/or the like.

In some embodiments, all components of the server 1100 can be included in a common casing such as, for example, a single housing that presents the server 1100 as an integrated, one-piece device for a user. In other embodiments, at least some components of the server 1100 can be in separate locations, housings, and/or devices. For example, in some embodiments, the memory/database 1130 can be in a separate housing from the controller 1105 and be in communication via one or more networks, each of which can be any type of network such as, for example, a local area network (LAN), a wide area network (WAN), a virtual network, a telecommunications network, and/or the Internet, implemented as a wired network and/or a wireless network. Any or all communications can be secured (e.g., encrypted) or unsecured, as is known in the art. The server 1100 can be or encompass a personal computer, a server, a work station, a tablet, a mobile device, a cloud computing environment, an application or a module running on any of these platforms, and/or the like.

As illustrated in FIG. 1, the controller can execute components (i.e., can execute computer-executable instructions corresponding to functionality associated with) jEngine 1110 and jBuilder 1120. The jEngine 1110 can deliver polymorphic content to the user device 1300 during operation such as, for example, via one or more text messages via the app 1310, via one or more custom interfaces via the vApp 1320, via one or more links to responsive web applications 1330, and/or the like. Specifically, the jEngine 1110 delivers the polymorphic content via vModule(s) 1150 and message flow(s) 1166 based on timing/gating and other programmed and learned information provided by vAgent(s) 1140 and/or the MIAgent(s) 1410. The jEngine 1110 also stores any user-specific information generated by vModule(s) 1150 and/or other components in the cloud 1200.

The jBuilder 1120 can generate the overall user experience, also characterized as a vJourney for a particular user, based on content authored by creatives and specialists in the field or domain in which the vJourney operates. Specifically, the jBuilder 1120 can generate and/or specify vModule(s) 1150, vSnippets(s) 1132, vMap(s) 1180/1180a, vAgent(s) 1140, message flow(s) 1164, and/or the like, for a specific vJourney.

FIG. 2 illustrates a non-limiting example of a vJourney 1160, which can generally be characterized as a set of sequential interactions with a user. As a real-world example, the vJourney 1160 can include a set of sequential interactions with a consumer (lender) of a bank loan, with the end goal of ensuring the loan is paid off in a timely manner. Put differently, vJourney 1160 can be characterized as sequences of digital interactions that can be conveyed through interactive modules to guide users to attain an end goal. Aspects disclosed herein are hence beneficial for the attainment of some concrete goal of a user.

The vJourney 1160 can be composed of a set of contiguous user interactions (each referenced here as vIX1 . . . vIXn 1162), where each vIX 1162 is to be completed by the user before moving on to the next vIX 1162. Said another way, as long as the user takes the necessary action to progress along with a vIX (e.g., provide the input asked for), the vIX will continue to deliver the next content in line until the end. In some instances, gating can be provided between vIXs, as described in more detail below. Continuing with the example of a bank loan, an example vIX 1162 can include an interactive sequence which asks and subsequently recommends to a user how much she should save every month. Another example vIX 1162 can include an interactive sequence which identifies areas of cost savings for the user's small business. Aspects disclosed herein are hence beneficial for making modular, incremental efforts towards achieving the user goal, which can be more manageable and less intimidating for a user when compared to the overall goal of paying off the loan.

In a few cases, the relationship between one vIX 1162 to the next is linear, i.e., the vJourney 1160 includes an indication of a single, subsequent vIX to be executed after a prior one is completed. In other cases, moving from one vIX 1162 to the next is non-linear or multi-branching, i.e., the next vIX is selected based on the execution of the prior vIX (e.g., whether the user successfully completed the prior vIX, user responds to vComponents on the previous vIX, other user states, and the like). In some implementations, a second vIX can be rendered after a first vIX after a certain time gap. For instance, following the completing of a first vIX after say e.g., about 5 minutes, about an hour, about 6 hours, about 12 hours, about a day, about 2 days, about a week, or about more than a week a second vIX can be rendered. As illustrated in FIG. 2, a decision-tree like structure can result depending on the interrelationships between the vIXs 1162 of a vJourney 1160, culminating in a ‘leaf’ node of the decision tree, vIXn 1162.

FIG. 2 also illustrates that each vIX 1162 is of a particular type—including corresponding vModules 1150 and message flows 1164. Each vModule 1150 includes a specification of sequence of user interactions within its corresponding vIX 1162. The user interactions can include, but are not limited to, presenting new content to the user (e.g., a set of easy-to-read, animated pages that educates a user on the process of repairing her business credit), nudging/reminding the user to take a specific action (e.g., linking a user in real-time to her loan specialist to discuss refinancing options), collecting active and/or passive user input (e.g., asking the user to select among a list of choices that represent their biggest hurdles to growing her business), and/or the like. The vModule 1150 can be operable for configuring and/or reconfiguring the sequence of user interactions within its corresponding vIX 1162 based on factor such as, but not limited to, prior use interactions, user preferences, and content that would be helpful to user based on information learned about the user. An example of a spontaneous reconfiguring of a vIX 1162 would be exposing the user to either of two pathways to brainstorm ways to improve her business depending on whether she is classified as a “Deliberate” or an “Instinctive” Thinker.

The message flow 1164 for a specific vIX 1162 can include a specification for the order of interaction with the user. For example, as illustrated in FIG. 2, the message flow 1164 can indicate that a vModule 1170 for an initial introduction to the vIX 1162 is presented first. Other interactions (including other vModules, if any), such as providing general tips to the user, can also be specified by the message flow. For example, a message flow 1164 can ask the user if she has stayed within the parameters of her spending plan for the day. In some implementations, message flow 1164 can be implemented in tandem with vModules 1150 to guide a user. In some implementations, messages can be dispatched via Agent (e.g., Agent 1140 in FIG. 1) which includes executable code configured to dispatch a message and/or a message flow 1164 to one or more users. In some implementations, messages can be dispatched via MIAgent (e.g., MIAgent 1410 in FIG. 1) which provides a communication interface with one or more humans (e.g., coaches, tutors, mentors, and/or the like, assigned to a user).

FIG. 2 also illustrates that a vIX 1162 can also encompass additional components such as, for example, a vAudio Stream 1166 that permits the user to receive an audio stream. For example, a user may have built a sleep plan during the course of her vJourney, and programmed the vJourney to call at bedtime with a 30-minute segment of white noise, an audio segment that automatically dials down in volume over 30 minutes and then hangs up.

FIG. 2 illustrates how each vModule 1150 includes a set of sequential pages (here, vPage(s) 1152) that are visually presented to the user. Similar to the decision-tree structure of a vJourney 1160, the vPages 1152 within a vModule 1150 can also be sequenced in a linear or multi-branching fashion, or combinations thereof.

Hence, a vPage 1152 is a representation of visual elements, similar to a web page, and can be static, interactive, or include combinations thereof. FIG. 2 illustrates that each vPage 1152 can include vComponent(s) 1154, vSnippet(s) 1132, and/or other elements 1156. Each of these are illustrated in broken lines, indicating that while each is optional, a vPage 1152 will include at least one of a vComponent 1154, a vSnippet 1132, or other element 1156. The other element 1156 can include any suitable, visually renderable element such as, for example, static text and/or image. A vPage 1152 might by way of example ask the user to identify her perceived obstacles to paying off her loan.

As illustrated in FIG. 3, each vComponent 1154 can include one or more user-interactive elements, such as, for example, a list (e.g., select the considerations that build your retirement plan) that the user can select one or more elements from, a text box for user entry, and/or the like. In some cases, a vComponent 1154 can consume a vSnippet 1132, as explained below. A vComponent 1154 might, by way of example, ask the user to select from among a set of possible reasons that would preclude her from paying off her loan. The set of possible reasons would be encapsulated in a vSnippet 1132, in which each individual reason is a vPayload 1170. Tags and logic may dictate whether certain vPayloads 1170 are expressed. For example, users with children might see children-related reasons in the list, whereas users without families will not see these reasons.

Each vSnippet 1132 included in the vPage 1152 and/or a vComponent 1154 includes one of one or more vPayloads 1170 (also sometimes referred to as a selected payload) associated with that vSnippet 1132. Each vPayload 1170 is an element that can be included in a vPage 1152 and/or a vComponent 1154 if certain criterion are met. Specifically, each vPayload 1170 can include an indication of one or more tags 1172, selection logic 1174 (i.e., for selection to be presented to the user), and a weight parameter 1176. A payload can generally be represented as:

vPayloadn {Tag1, Tag2 . . . }, logic, weight

Each tag 1172 and logic 1174 associated with a vPayload 1170 is used to determine if that vPayload is to be selected for presentation to the user. The weight 1176, which can be defined by any floating point number or similarly dense, well-ordered set of scalars associated with a vPayload 1170, is used to determine the probability, once that payload has been selected for presentation, that that payload is presented to the user by comparing the weights of all selected payloads. Applying random selection to multiple selected payloads to select a single payload for user presentation, based on their respective weight 1176 parameters, can result in content polymorphism not only across multiple users but also at different time points in interacting with the same user.

How a vPayload 1170 is selected for a given vSnippet 1132 can be explained with respect to an example. Suppose the example vSnippet_example includes the following payloads:

vPayload1 →{Tag1}, logic = user_male, weight = 1
vPayload2 →{Tag1, Tag2}, logic = user_female, weight = 5
vPayload3 →{Tag1}, logic = 1, weight = 0.5
vPayload4 →{Tag10}, logic = 1, weight = 10

Further, consider the following criterion (e.g., established by the jBuilder 1120) selecting a payload for vSnippet_example—that a) the tag must match “Tag1”, and that b) the logic must match the demographic information that the user is male.

At a first step of payload selection, the criterion logic is compared against the logic for each payload in vSnippet_example. Here, vPayload1, vPayload3, and vPayload4 all match the requirement that the user is male, and vPayload2 is dropped. In this example, vPayload3 and vPayload4 having a logic=1 is assumed to mean that they are always considered to match the criterion logic. Examples for when a vPayload's logic might be set to 1 can include, but is not limited to when 1) a vPayload should be universally available, and 2) when tags alone are sufficient to describe the expressable context of the vPayload.

In a next step, the criterion tag(s) (which can be optional) are compared against the tags for vPayload1, vPayload3, and vPayload4. Here, vPayload1 and vPayload3 both have the requisite “Tag1” while vPayload4 does not, and is dropped.

In a next step, one of vPayload1 and vPayload3 is randomly selected based on their respective weight parameter. Examples of such weighted, random selection can include, but are not limited to, randomized selection after linear mapping of the weight parameters, after exponential mapping, after quadratic mapping, after squaring the weight parameters, and/or the like. Here, vPayload1 has a weight of 1 and vPayload2 has a weight of 0.5, so vPayload1 has a ⅔^{rd} chance of selection, and vPayload2 has a ⅓^{rd} chance of selection as the selected payload for its corresponding vSnippet_example, which is then presented on its corresponding vPage 1152 and/or vComponent 1154. The presented aspect of the vPayload can be any suitable entity (sometimes referred to as a payload ‘value’) such as, for example, text, an image, and/or the like.

The weight 1176 of any vPayload 1170 can be modified over time based on factors such as which vPayload gets the highest level of attention, the correlation between vPayloads, the likelihood and intensity of daily engagement of the user, efficacy of the behavioral techniques being applied to the user, and the user's progress towards overall goal and/or sub-goal attainment. In this manner, aspects disclosed herein are useful for dynamic generation of digital interactive content, and specifically for presenting polymorphic content based on runtime modification of payload weights over time, and in a learned manner.

A simple example of a vSnippet 1132 (say, “vSnippet_yes_no”) is one that includes three payloads related to responses a user can provide to a question:

vPayload1 →{absolute}, logic = 1, weight = 1. Value = “yes”
vPayload1 →{absolute}, logic = 1, weight = 1. Value = “no”
vPayload1 →{ambiguous}, logic = 1, weight = 1. Value = “maybe”

Such a vSnippet 1132 can be consumed by a vComponent 1154 such as to, for example, provide a selectable list (vComponent) of yes/no/maybe (consumed vSnippets) options in response to a question asked of the user in the corresponding vPage.

Another example of vSnippet 1132 (say, “vSnippet_skipwork”) can be used to illustrate the various ways that vSnippets can be consumed. vSnippet_skipwork can include the following payloads:

vPayload1 →{ }, logic = 1, weight = 1. Value = “feeling lazy”
vPayload1 →{ }, logic = 1, weight = 1. Value = “not in the mood”

These payloads can be flexibly rendered to the user as part of a selectable list (i.e., as part of a vComponent), or provided as a static list directly in a vPage (i.e., as an embedded vSnippet) as an informative listing of reasons why people typically skip work.

In some implementations, vSnippets can embed media (e.g., images, animated Graphics Interchange Format, animations, and/or the like) through text within vModules (sometimes referred to as “vVisualSnippets”). An example vSnippet “v.viz_good_job” consisting of three vPayloads is shown below:

″v.viz_good_job″:
[
{″val″:″https://previews.123rf.com/images/arcady31/arcady311607/arcady31160700035/
60391366-good-job-banner.jpg″,},
{″val″:″https://previews.123rf.com/images/ratoca/ratoca1509/ratoca150900023/44734817-
good-job-symbol.jpg″,},
{″val″:″https://media.tmicdn.com/catalog/product/cache/0f831c1845fc143d00d6d1ebc49f446a/
g/o/good-job-2-temporary-tattoo_gen-87.jpg″,″tags″:[″strong″],},
],

FIG. 3 also illustrates that vPayloads 1170 within and/or across vSnippets 1132 can be linked and/or otherwise associated with each other to form a map 1180. In some implementations, map 1180 represents relationships between two or more vSnippets 1132. For example, a two-dimensional map 1180 can represent relationships between two vSnippets 1132. An example representation of a two-dimensional map 1180 could include a table with the rows representing vPayloads associated with one vSnippet 1132 and columns representing vPayloads associated with another vSnippet 1132. Put differently, ne vSnippet 1132 can be represented as a row in map 1180 and the other vSnippet can be represented as a column in map 1180. The map 1180 can be a matrix of numbers (e.g., floating-point numbers). These numbers can either be a) a weight (between 0 and 1); or b) an integer (that signifies count). These numbers can represent the relationship between the row vSnippet and the column vSnippet. Although a two-dimensional map is represented herein for simplicity, a map can be on n-dimension representing relationships between n vSnippets 1132.

Consider the following example that illustrates a map 1180 based on an example row vSnippet and an example column vSnippet.

An example row vSnippet “p.savings obstacles” that describes various possible obstacles towards a goal of saving money. Some vPayloads for this vSnippet can include (i.e., example possible obstacles)

1) Forgetting to save

2) Impulsive spending

3) Buying latest and newest stuff

4) Not enough money coming in

5) Daily unexpected line items

6) Upcoming life event

7) Unforeseen medical expense

8) Unforeseen auto expense

9) Unforeseen housing expense

10) Too lazy to make a budget

11) Too scared to make a budget

12) Buying stuff when stressed or upset

13) Ashamed to say no when loved ones want stuff

14) Hard to say no to loved ones when they want stuff

15) Expensive tastes

16) Eating out too much

Now consider a column vSnippet “p.savings strategies” that describe various possible options that one can pursue to improve their chances to reach their savings goal. Some vPayloads for this vSnippet can include:

a) Limit buying stuff that the user does not need

b) Look for bargains in more places

c) Cut out luxury buys for the time being

d) Try cooking simple dishes with fresh ingredients

e) Channel buyer's remorse

f) Lock credit cards

g) Use more coupons

h) Spend less on things

i) Find more tax credits

j) Look for cheaper car insurance

k) Get on an auto savings plan

An example map with the above row vSnippet and column vSnippet to recommend a strategy to a user based on various obstacles is shown below.

vMap: p.map_savings_obstacles_x_savings_strategies

| | a | b | c | d | e | f | g | h | i | j | k |
|---|---|---|---|---|---|---|---|---|---|---|---|
| 1) | | 1 | 1 | | 1 | | | | 1 | | |
| 2) | | | 1 | | | | | | | | |
| 3) | | | | | 1 | | | | | | |
| 4) | | | 1 | | | | | | | | |
| 5) | | | 1 | | | | | | | | |
| 6) | | 1 | 1 | | | | 1 | | 1 | | |
| 7) | | 1 | 1 | | | | | 1 | 1 | | |
| 8) | | 1 | | | | | | 1 | | | |
| 9) | | | 1 | | | | | 1 | | | |
| 10) | | | 1 | 1 | | | | | 1 | | |
| 11) | | 1 | | | | | | | | | |
| 12) | | | 1 | | | | | | | | |
| 13) | 1 | | | | | | | | | | |
| 14) | 1 | | | | | | | | | | |
| 15) | 1 | | | | | | | | | | |
| 16) | 1 | | | | | | | | | | |

In the above example, vMap indicates that an obstacle forgetting to save is related to options look for bargains in more places, cut out luxury buys for the time being, channel buyer's remorse, and find more tax credits. Put differently, if a user forgets to save, such a user can be given options such as looking for bargains, cutting out luxury buys, channeling buyer's remorse, and finding tax credits as options to reach their savings goal.

Map 1180 can specify strategies that can be recommended for different obstacles (e.g., strategies to: reach a savings goal, attain a sleep goal, avoid procrastination, avoid distraction, reduce negative emotions, etc.). Map 1180 can also be used to specify habits that can boost various goals, map business types to business goals, map business pain points to business plan elements, map psychological phenomena to a context, and/or the like.

As seen above each map 1180 includes at least an association of two vPayloads 1170 (e.g., a payload associated with row vSnippet, and a payload associated with column vSnippet) (here, vPayloadm 1170m and vPayloadn 1170n) having a weight (Wm,n) associated therewith, which can be an indication of a strength of the association. A map 1180 can be static and/or learnable. A static map can include values and/or weights that do not change until an author and/or coach updates it. Learnable or learned maps can have their weights constantly adjusted through user interaction. Put differently, the weight Wm,n can be modified over time.

As an example, learnable maps can be implemented using an incrementing method and/or a re-normalization method. In the incrementing method, the weights can be adjusted upwards when their corresponding vPayload-pairs (e.g., row vSnippet and/or column vSnippet pair) receive more attention or selection among users, when these pairs are correlated with greater efficacy of the behavioral techniques being applied to the user, and with the user's progress towards overall goal and/or sub-goal attainment. Such a learnable map can be a majority of users and/or a specific number of users pick a specific option in a given situation.

For example, a learnable map with an incrementing weight can be implemented when a specific number of users (e.g., more than 400 users, more than 500 users, more than 600 users, and/or the like) who struggle with impulsive buying choose the option lock-credit-cards-in-box strategy amongst other possible strategies to attain a savings goal. For such users, this strategy subsequently shows more usage and correlates with a higher amount of savings generated along the vJourney. The weight of the vPayload of impulsive buying and lock-credit-card-in-box can be adjusted upwards in order ensure that subsequent users who choose impulsive buying as a savings obstacle sees the lock-credit-cards-in-box strategy as a top strategy in recommendation.

The re-normalization method can be implemented to pick a value or a specific number of top values stochastically. Put differently, in response to one or more users picking a value in a given situation, the re-normalization method can be applied to increase the probability of that specific value in that situation. In re-normalization method, the vPayload weights can be re-adjusted across a row and/or a column. For instance, the value “0.1” can be added to a specific element in a row and/or column in order to re-adjust the weights so that the sum across each row or each column is 1).

In this manner, associations between vPayloads can be useful for modifying aspects of the vJourney, vIX, vModules, and/or the like to provide a more relevant user experience. For example, a vPayload used to gauge the challenges the user is facing in saving money can be associated via a vMap to other vPayloads, each offering a saving strategy specific to the user's challenge. The jBuilder can then modify the vJourney to ensure that the associated vPayload follows next.

FIG. 3 also shows an additional/alternate representation that shows how each vMap associating 2 vSnippets together can be represented by an m×p matrix—where m is the number of vPayloads in the first vSnippet, and p is the number of vPayloads in the second vSnippet. In real-world scenarios, many of the values in a vMap may be 0, and vPayloads will not be densely cross-associated. Furthermore, the space of possible associations between n vSnippets contains n² number of matrices, each of m×p—where m and p are the number of vPayloads within the 2 vSnippets being associated together—1180a. In real-world scenarios, only a subset of possible pairs of vSnippets will have associated vMaps.

As discussed in the lock-credit-cards-in-box example above, vMaps can be learned and re-weighted as different associations prove more effective. The weights associated with a vPayload pair can be changed. This fosters self-improvement, since the vMap parameters gradually become more representative of the user's preferences, selections, etc. Put differently, as the vMaps re-weight themselves based on past learnings, the vJourney is automatically modified based on these learnings. Therefore, vJourneys improve the user experience as the vMaps are modified. FIGS. 1-3 hence illustrate the modular (e.g., one vIX, or one vModule, or one vPage at a time), hierarchical (e.g., vSnippets are embedded in vPages, a series of which form a single vModule, and multiple vModules are cobbled together along with other types of vIXs to provide a unified vJourney to a user) and interchangeable nature (e.g., by randomized selection of shortlisted vPayloads within a vSnippet) of the digital content presented to a user based on the innovative aspects disclosed herein.

Further, innovative aspects disclosed herein can encompass gating of digital content provided to the user at any hierarchical level (e.g., vIX, vModule, vPage etc.) to control content delivery to the user to optimize user interaction. Said another way, any hierarchical level can include timing (e.g., at certain times, within certain time windows, etc.) and/or other gating parameters for content delivery. Such gating parameters can be manually prespecified, programmed, and/or learned from prior user interactions such as, for example, increasing a time window for user response to a question on a vPage if on prior occasions the user has taken longer than expected to respond. An example of gating in between two vIXs would be delaying the second vIX delivery to the day after the user completes the first vIX experience. An example gating that happens within a single vIX would be displaying a vPage for a predetermined amount of time (e.g., a vPage complimenting the user on their progress, and having no other content) before automatically moving on to the next vPage.

These delays and/or time windows can be: a) manually specified, b) programmed to be automated, and/or c) learned.

In the manually specified case, a coach and/or author can manually dispatch a payload to be rendered to a user. For instance, a coach and/or author can push a vAgent to dispatch a payload to notify a user that the user's CARES PPP loan application is ready to be filled out.

In some implementations, the delays and/or time windows can be programmed to be automated. For example, a vAgent can be programmed to automatically dispatch a vPayload after a specific time has elapsed. For instance, when a user's pay back amount on a loan passes an amount that is specified by the lender, a vAgent can automatically render an interface asking the user if the user would like to renew or re-up the user's loan amount.

In some implementations, the delays and/or time windows can be learned. For example, consider that the vAgent dispatches a link for a user to tap on (e.g., ‘Tap on this link to see what I got for you today: http://tapme.io/happyrhino12345’). If the user does not tap on the link, a vAgent that acts as an autonudger dispatches a nudge to the user after a specific amount of time (e.g., 2 hours). If the nudge results in the user tapping this link, the next time the autonudger can dispatch the link at an earlier time (e.g., 1.8 hours). If the nudge does not result in the user tapping this link, the next time the autonudger can dispatch the link at a later time (e.g., 2.5 hours). The learning can include re-weighting the weights on the vPayloads associated with their corresponding vSnippets.

A example Autonudger vSnippet is shown below:

```
  ″autonudger-taplink-
1″:{″_ver″:″1″,″_author″:″v″,″_ctrl_fire_cooloff″:″7″,″_payload″:″Don't be scared of the link LOL ;-)″,},
  ″autonudger-taplink-
2″:{″_ver″:″1″,″_author″:″v″,″_ctrl_fire_cooloff″:″7″,″_payload″:″The blue link awaits. . .″,},
  ″autonudger-taplink-
3″:{″_ver″:″1″,″_author″:″v″,″_ctrl_fire_cooloff″:″7″,″_payload″:″Well [u.fname], give it a tap!″,},
  ″autonudger-taplink-
4″:{″_ver″:″1″,″_author″:″v″,″_ctrl_fire_cooloff″:″7″,″_payload″:″Whatcha waiting for [u.fname]lol″,},
  ″autonudger-taplink-
5″:{″_ver″:″1″,″_author″:″v″,″_ctrl_fire_cooloff″:″7″,″_payload″:″Give that link a tap [v. sal]!″,},
  ″autonudger-taplink-
6″:{″_ver″:″1″,″_author″:″v″,″_ctrl_fire_cooloff″:″7″,″_payload″:″You have link, up to you to tap it!″,},
  ″autonudger-taplink-
7″:{″_ver″:″1″,″_author″:″v″,″_ctrl_fire_cooloff″:″7″,″_payload″:″You want to tap that Blue
Link of Life [u.fname];-)))″,},
  ″autonudger-taplink-
8″:{″_ver″:″1″,″_author″:″v″,″_ctrl_fire_cooloff″:″7″,″_payload″:″Your next step awaits [v.sal]. . .″,},
  ″autonudger-taplink-
9″:{″_ver″:″1″,″_author″:″v″,″_ctrl_fire_cooloff″:″7″,″_payload″:″That link will expire soon [v.sal]!″,},
  ″autonudger-taplink-
10″:{″_ver″:″1″,″_author″:″v″,″_ctrl_fire_cooloff″:″7″,″_payload″:″Didn't like that link [v. sal]?″,},
  ″autonudger-taplink-
11″:{″_ver″:″1″,″_author″:″v″,″_ctrl_fire_cooloff″:″7″,″_payload″:″Not a fan of tapping links [v.sal]?″,},
  ″autonudger-taplink-
12″:{″_ver″:″1″,″_author″:″v″,″_ctrl_fire_cooloff″:″7″,″_payload″:″Am I being too pushy [v.sal]?″,},
```

In a similar manner, consider a situation in which a vJourney with a first vIX and a second vIX is completed by a set of first users. Suppose the first vIX and the second vIX are delivered to these set of first users on the same day and the data for these set of first users is then collected. If the data indicates that a majority of these set of first users complete the first vIX but do not start the second vIX, then the systems and methods described herein can modifythe time delay between the first vIX and the second vIX based on such learning. Put differently, based on the data that was collected the systems and methods disclosed herein can learn to modify the time delay such that the first vIX is delivered on one day and the second vIX is delivered on the next day. In a similar manner, gating within a single vIX can also be learned based on previous data that exists for a vJourney.

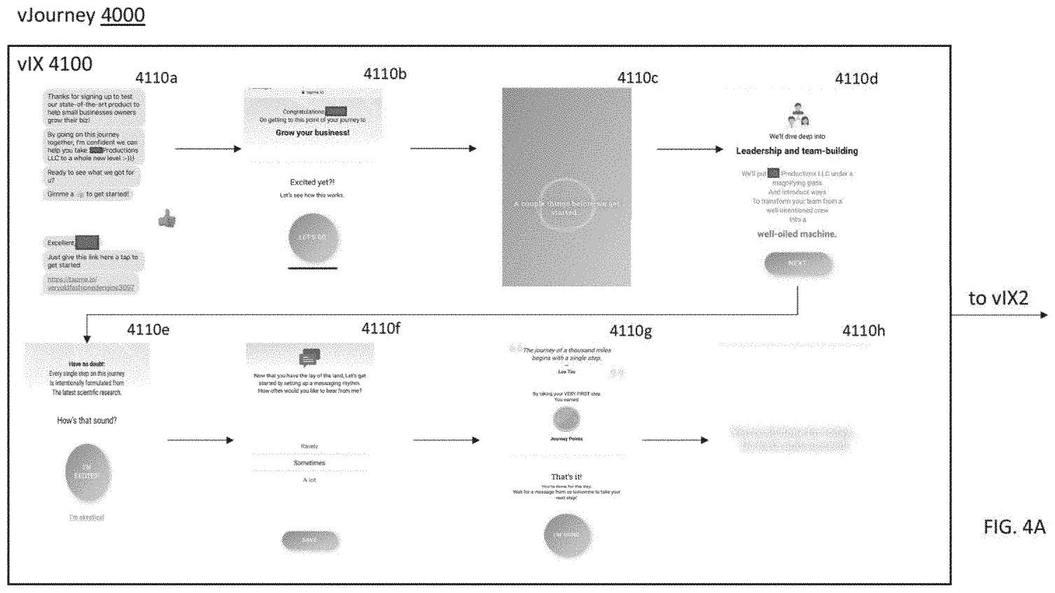

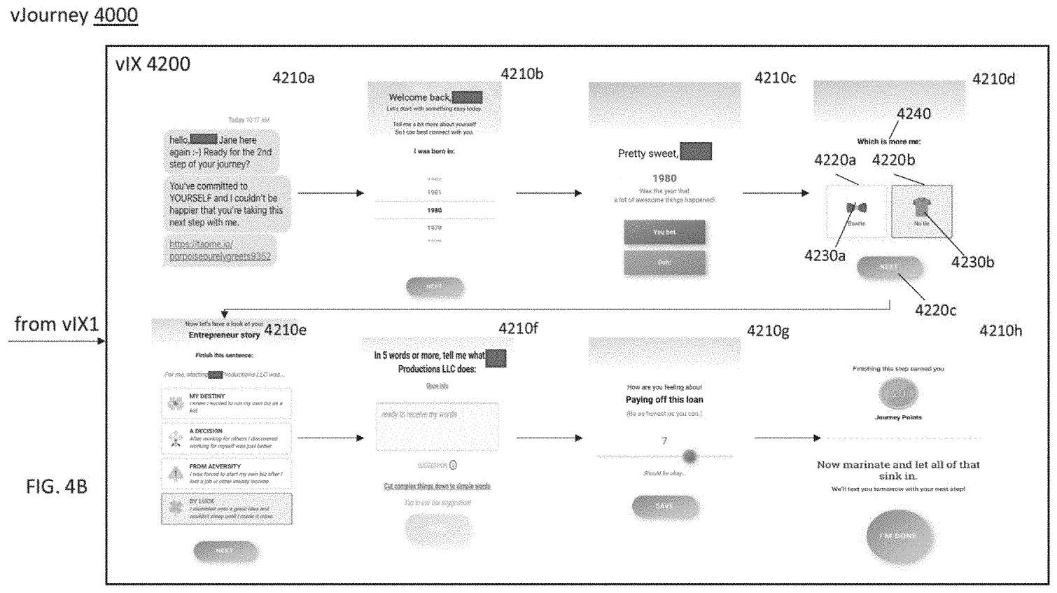

FIGS. 4A-4B illustrates a portion of an example vJourney 4000, including a first vIX/VModule 4100 followed by a second vIX/vModule 4200 (referred to hereon as vIXs, for ease of explanation), a day after the user completes the set of interactions associated with the vIX 4100. Said another way, the user completes vIX 4100 before she is permitted to proceed to vIX 4200. Further, vIX 4100 and vIX 4200 are each a series of interactions that will continue responsive to the user till they reach their respective ends (vPages 4110h, 4210h respectively.

FIGS. 4A-4B also illustrate message flow, as illustrated in the text exchanges on a mobile texting app of the user in screens 4110a, 4210a.

FIGS. 4A-4B also illustrate vPages 4110b-4110h of vIX 4100, and vPages 4210b-4210h of vIX 4200.

The vPage 4110c illustrates gating within vIX 4110a. Here, the vPage 4110c is displayed for a predetermined amount of time (say 5 seconds), and then automatically advances to vPage 4110d.

The vPage 4110e illustrates how, depending on user input, a decision can be made on the next vPage to be presented to the user. Here, a user selecting “I'm Excited” will lead to the illustrated vPage 4110f, while a user selecting “I'm skeptical” can lead to a different vPage (not shown).

The vPage 4110f illustrates how gating parameters associated with gating between vIXs can be modified based on user input. Here, depending on whether the user decides to hear from the service rarely, sometimes, or a lot, the gating between vIXs can be set to (for example) every two days, every day, or every 12 hours.

The vPage 4210d is an example of how a vPage can include vComponents 4220a-4220c. The vComponent 4220a, 4220b are interactive, selectable options, while the vComponent 4220c is an interactive button that the user can click on to move to the next page 4210e. The vComponent 4220a, 4220b have embedded vSnippets 4230a, 4230b respectively, each here showing a selected vPayload, of value “bowtie” and its associated image of a bowtie, or of value “No tie” and its associated image of a t-shirt. The vPage 4210d also illustrates another element 4240, which is static text on this page.

The vPages 4210b, 4210d, 4210e, 4210f, and 4210g all illustrate acquiring information about user preferences, the user's personality, the user's business, which can be used in various ways as described herein. For example, if the user specifies that she is more “not tie” in vPage 4210d, the weights associated with vPayloads that include more informal language can be increased. As another example, the user's description of what their business does at vPage 4210f can be used to decide which subsequent vIX should be deployed. As yet another example, the user's indicating that they feel just okay about paying off the loan at vPage 4210g can be used to select a vPage that provides a motivational, uplifting quote to the user.

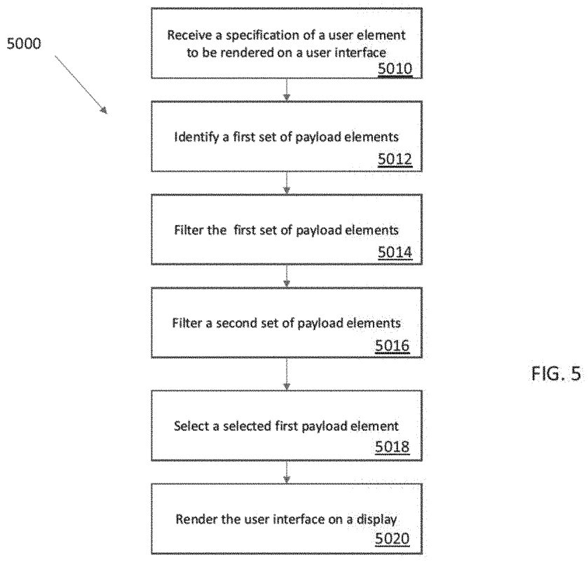

FIG. 5 is a flowchart of a method 5000 executed by a system, such as system 1000 shown in FIGS. 1-3, for dynamic generation of a user interface for display on a display device (e.g., display device such as mobile device). The user interface can be a vPage including vComponents. A sequence of vPages can form vIXs and a series of vIXs can form a vJourney. Each vJourney can be associated with one or more user parameters. For instance, a vJourney can be specifically designed to a male user. In such a scenario, the user parameter would be male gender.

At 5010, the method 5000 receives a specification of a user interface element (e.g., a vSnippet) to be rendered on the user interface (e.g., vPage and/or vComponent). The specification can include keywords and/or tags, such as tag 1172 in FIG. 3. In some implementations, the vSnippet can be a static image such as vSnippets 4230a and 4230b in FIG. 4B. In some implementations, vSnippets can in the form of text. For example, a vPage inquiring how often a user would prefer receiving updates could include vSnippets in the form of text such as “Rarely” and “Frequently.” In some implementations, vSnippets can be in the form of audio. For example, a vPage with instructions to perform two different kinds of workout could include vSnippets for each of the workout in the form of audio. The audio can provide instructions to the user on the corresponding workout. In some implementations, vSnippets can be in the form of hyperlink. For example, a vPage with instructions to pay bills for different utilities can include vSnippets as hyperlinks corresponding to each utility that direct the user to the corresponding webpage to pay the bill. In some implementations, vSnippets can include a combination of one or more images, text, audio, and/or hyperlinks.

As discussed above, each vSnippet can include a set of payload elements that can be included in the vPage and/or vComponents. Each payload element can include one or more keywords, selection logic, and a payload weight. For example, consider a payload element vPayload1.

vPayload1→{absolute}, logic=1, weight=1. Value=“yes”

As seen above, vPayload1 includes keyword “absolute,” selection logic defined as “1,” and a weight “1.”.

At 5012, the method 5000 can identify the set of payload elements associated with that vSnippet to be rendered on the vPage and/or vComponent. For instance, if a vSnippet includes two payload elements vPayload1 and vPayload2, at 5012, these two payload elements can be identified.

At 5014, the method 5000 can filter the set of payload elements by comparing the keywords in the specification to the keywords in the payload elements. For example, consider a vSnippet with the following payload elements.

vPayload1 →{absolute}, logic = 1, weight = 1. Value = “yes”
vPayload2 →{absolute}, logic = 1, weight = 1. Value = “no”
vPayload3→{ambiguous}, logic = 1, weight = 1. Value = “maybe”

Suppose the specification that was received indicates that the tag and/or keyword must match “absolute,” then the method eliminates vPayload3 by comparing the tags of vPayload1, vPayload2, and vPayload3. In this manner, the method 5000 filters out vPayload1 and vPayload2 from the set of vPayload1, vPayload2, and vPayload3.

At 5016, the filtered set of payload elements can be further filtered by comparing the logic within each payload element to the user parameter. For instance, consider the example vSnippet disclosed previously with payload elements as shown below:

vPayload1 →{Tag1}, logic = user male, weight = 1
vPayload2 →{Tag1, Tag2}, logic = user female, weight = 5
vPayload3 →{Tag1}, logic =1, weight = 0.5
vPayload4 →{Tag10}, logic = 1, weight = 10

If the specification includes a keyword “Tag1” and if the vJourney is associated with a male user, then in step 5014, vPayload4 is eliminated based on the comparison of the keywords. In step 5016, vPayload2 is eliminated because the logic in vPayload2 is associated with a female user while the user parameter is male user.

Therefore, following step 5016, only vPayload1 and vPayload3 remain. At 5018, one of the remaining payloads following the filtering steps in 5012 and 5014 is randomly selected. In the above example, one of vPayload1 and vPayload3 is randomly selected based on their respective weight parameter. As discussed above, examples of such weighted, random selection can include, but are not limited to, knock-on-knock-off selection (where vPayloads are turned off completely after one misfire), randomized selection after linear mapping of the weight parameters, after exponential mapping, after quadratic mapping, after squaring the weight parameters, and/or the like.

At 5020, the selected vPayload is rendered on the vPage in the form of a text, image, and/or the like. In this manner, vPages can be dynamically generated for display on a display device. A sequence of vPages can form vIXs and a series of vIXs can form a vJourney. A vJourney can guide a user to achieve a specified goal.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification, unless clearly indicated to the contrary, should be understood to mean “at least one.”

The phrase “and/or,” as used herein in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of” shall have its ordinary meaning as used in the field of patent law.

As used herein in the specification, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising,” “including,” “carrying,” “having,” “containing,” “involving,” “holding,” “composed of” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for dynamic generation of a user interface for display on a display device of a user, comprising:
(a) receiving a first specification of a user interface element to be rendered on the user interface, wherein the specification of the user interface element includes one or more first user interface keywords, wherein the user interface is a first user interface of a set of sequential user interfaces associated with the user, and wherein the set of sequential user interfaces is associated with one or more user parameters of the user;
(b) identifying a first set of payload elements as associated with the user interface element and deemed selectable for rendering as the user interface element on the user interface, each payload element including a specification of:
one or more payload keywords;
selection logic; and
a payload weight;
(c) filtering the first set of payload elements based on comparing the one or more payload keywords of each payload element of the first set of payload elements against the one or more user interface keywords to generate a second set of payload elements;
(d) filtering the second set of payload elements based on comparing the selection logic of each payload element of the second set of payload elements against the one or more user parameters to generate a third set of payload elements;
(e) selecting, via weighted random selection, a selected first payload element from the third set of payload elements based on the payload weight of each payload element of the third set of payload elements; and
(f) rendering the first user interface on the display of the display device with the selected first payload element as the user interface element.

2. The method of claim 1, further comprising:
(g) receiving a second specification of the user interface element to be rendered on a second user interface of the set of sequential user interfaces, wherein the specification of the user interface element includes one or more second user interface keywords;
(h) performing steps (b)-(e) to select a selected second payload element from the first set of payload elements, wherein the selected second payload element is different from the selected first payload element by virtue of the weighted random selection; and
(i) rendering the second user interface on the display of the display device with the selected second payload element as the user interface element.

3. The method of claim 1, wherein the selected first payload element and another payload element associated with a second user element are associated via a payload map, further comprising:
(j) receiving, after step (f), from the user, a selection of the first payload element; and
(k) modifying a specification of the second user interface of the set of sequential user interfaces to include the other payload element.

4. The method of claim 1, wherein the user interface element includes one or more of text, an image, an animated image, a video, audio, a hyperlink, or a phone call.

5. The method of claim 1, wherein the user interface element is a first user interface element of a set of user interface elements on the first user interface, the set of user interface elements defining a component of the first user interface.

6. The method of claim 5, wherein the component includes a list and each user interface element of the set of user interface element is a selectable option of the list.

7. The method of claim 5, wherein the component includes a set of buttons and each user interface element of the set of user interface element is a selectable button of the set of buttons.

8. The method of claim 1, the rendering at step (f) further comprising rendering the first user interface as part of rendering a module of user interfaces of the set of user interfaces.

9. The method of claim 8, wherein the module is associated with:
one or more user interactions different from the set of user interfaces; and
an order for the contiguous rendering, responsive to user input, of each user interface within the set of user interfaces, and for each interaction of the one or more user interactions.

10. The method of claim 9, wherein the module is further associated with timing information for the rendering of at least one user interface of the set of user interfaces, for at least one interaction of the one or more user interaction, or both.

11. The method of claim 10, wherein the timing information is based on one or more of the payload elements.

12. The method of claim 8, the rendering at step (f) further comprising rendering the module of user interfaces as a first module of a set of modules.

13. The method of claim 9, the rendering at step (f) further comprising rendering, after a first time duration after the first module, a second module of the set of modules.

14. A system for dynamic generation of a user interface for display on a display device of a user, the system comprising a controller configured to:
(i) receive a first specification of a user interface element to be rendered on the user interface, wherein the specification of the user interface element includes one or more first user interface keywords, wherein the user interface is a first user interface of a set of sequential user interfaces associated with the user, and wherein the set of sequential user interfaces is associated with one or more user parameters of the user;
(ii) identify a first set of payload elements as associated with the user interface element and deemed selectable for rendering as the user interface element on the user interface, each payload element including a specification of:
one or more payload keywords;
selection logic; and
a payload weight,
(iii) filter the first set of payload elements based on comparing the one or more payload keywords of each payload element of the first set of payload elements against the one or more user interface keywords to generate a second set of payload elements,
(iv) filter the second set of payload elements based on comparing the selection logic of each payload element of the second set of payload elements against the one or more user parameters to generate a third set of payload elements, and
(v) select, via weighted random selection, a selected first payload element from the third set of payload elements based on the payload weight of each payload element of the third set of payload elements; and
(vi) transmit, to the display device, a specification of the first user interface with the selected first payload element as the user interface element, such that the display device render the first user interface on the display with the selected first payload element as the user interface element.

15. The system of claim 14, wherein the controller is further configured to:
(vii) receive a second specification of the user interface element to be rendered on a second user interface of the set of sequential user interfaces, wherein the specification of the user interface element includes one or more second user interface keywords;
(viii) perform steps (ii)-(v) to select a selected second payload element from the first set of payload elements, wherein the selected second payload element is different from the selected first payload element by virtue of the weighted random selection; and
(ix) transmit to the display device the selected second payload element, such that the display device renders the second user interface on the display with the selected second payload element as the user interface element.

16. The system of claim 14, wherein the selected first payload element and another payload element associated with a second user element are associated via a payload map, and
wherein the controller is further configured to:
(x) receive, after (vi), from the user, a selection of the first payload element; and
(xi) modify a specification of the second user interface of the set of sequential user interfaces to include the other payload element.

17. The system of claim 14, wherein the user interface element includes one or more of text, an image, an animated image, a video, audio, a hyperlink, or a phone call.

18. The system of claim 14, wherein the user interface element is a first user interface element of a set of user interface elements on the first user interface, the set of user interface elements defining a component of the first user interface.

19. The system of claim 18, wherein the component includes a list and each user interface element of the set of user interface element is a selectable option of the list.

20. The system of claim 18, wherein the component includes a set of buttons and each user interface element of the set of user interface element is a selectable button of the set of buttons.

21. The system of claim 14, wherein the controller is further configured to transmit a module of user interfaces, such that the display device renders, at (vi), the first user interface as part of rendering the module of user interfaces of the set of user interfaces.

22. The system of claim 21, wherein the module is associated with:
one or more user interactions different from the set of user interfaces; and
an order for the contiguous rendering, responsive to user input, of each user interface within the set of user interfaces, and for each interaction of the one or more user interactions.

23. The system of claim 22, wherein the module is further associated with timing information for the rendering of at least one user interface of the set of user interfaces, for at least one interaction of the one or more user interaction, or both.

24. The system of claim 23, wherein the timing information is based on one or more of the payload elements.

25. The system of claim 21, wherein the controller is further configured to transmit the module of interfaces, such that the display device renders, at (vi), the module of user interfaces as a first module of a set of modules.

26. The system of claim 22, wherein the controller is further configured to transmit a second module of the set of modules to the display device and to render, at (vi), the second module after a first time duration after the first module.
